(19) United States
(12) Patent Application Publication
(10) Pub. No.: US 2009/0063687 A1
(43) Pub. Date: Mar. 5, 2009

(54) Hybrid connection model

(75) Inventor: Mladen Turk, Zagreb (HR)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(73) Assignee: Red Hat, Inc.

(21) Appl. No.: 11/897,182

(22) Filed: Aug. 28, 2007

(51) Int. Cl. G06F 15/16

(52) U.S. Cl. 709/227

(57) ABSTRACT

A connection manager to manage connections between a web server using a hybrid connection model. The hybrid connection model is optimized to minimize system resources necessary to maintain an idle connection The hybrid connection model decreases resources required during idle times by using a single or set of poller threads to monitor for socket events for all idle connections. The connection is then assigned a worker thread when further data is ready to be transferred over a connection.

### TECHNICAL FIELD

Embodiments of the present invention relate to management of connections between clients and web servers. Specifically, the embodiments relate to a method and apparatus for reducing the number of threads required to manage connections by assigning idle connections to a common polling thread and releasing working threads until needed to service data transmission over the connection.

### BACKGROUND

Web servers 1, as illustrated in FIG. 1, provide a range of resources 3 including web pages, database access and multi-media resources over networks 7 including the Internet. These resources 3 are accessed by various web client applications 9A-C such as web browsers, specialized client applications and media players. Large numbers of clients and their host machines 13A-C can attempt to connect to a web server 1. This requires the web server 1 to service a large number connections simultaneously thereby consuming considerable processing resources. Each connection is assigned to a separate working thread 5 to manage communication across the connection. Each thread 5 requires memory and processing resources. This creates an upper limit on the number of threads and consequently the number of connections that a web server 1 can manage at one time based on the memory and processor resources of the web server machine.

Each thread 5 servicing a connection receives requests from a client application 9A-C, services the requests and sends the requested data to the client application 9A-C in response to the requests. Connections are closed by the client application 9A-C when the client application 9A-C has finished utilizing the services offered by the server. The thread servicing the connection waits idly between service requests and the closure of the connection. In many instances the client application stops utilizing the connection due to an unexpected termination of the client application 9A-C or failure of the client machine 13A-C and the connection is not properly closed. Also, many types of connections are used infrequently. Web browsers 9A-C make requests for a web page and related data to display to a user. The user may spend a considerable amount of time viewing a web page before requesting another webpage. As a result, the thread assigned to the connection spends a considerable amount of time idle, but is still consuming memory and processor resources.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a diagram of a web server and client system.

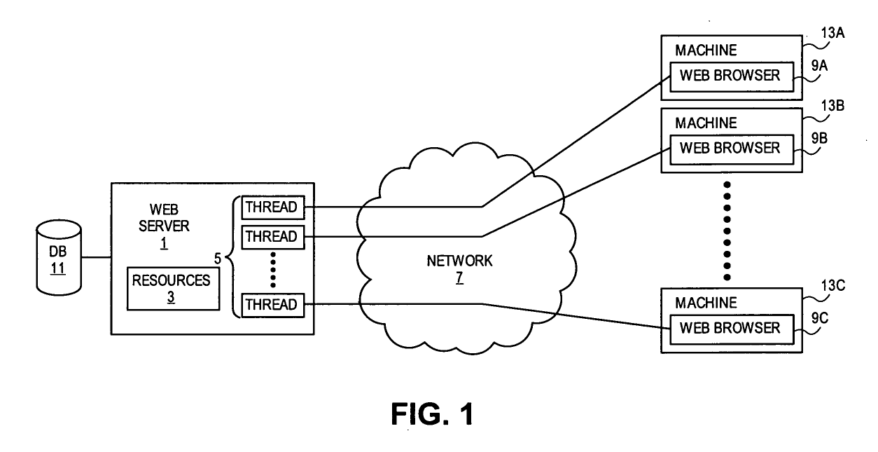

FIG. 2A is a diagram of one embodiment of a system for providing a web server.

FIG. 2B is a diagram of one embodiment of an organization of web server related modules.

FIG. 3 is a diagram of one embodiment of a network for providing web services.

FIG. 4 is a flowchart of one embodiment of a hybrid connection model.

### DETAILED DESCRIPTION

Described herein is a method and apparatus for managing connections between a web server or similar server resource and a set of clients. The connection model, referred to herein as a ‘hybrid connection model,’ decreases the number of threads and thereby the amount of resources consumed by connections between the server and clients. The inactive connections are assigned to a set of polling threads and the working thread is released. A working thread is assigned again to the connection when an action is needed. Connections that are inactive for an extended period of time can be maintained with minimum computer resources. A timeout period can be tracked to close those connections that are no longer in use.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be born in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “accepting,” “assigning,” “requesting,” “releasing,” “closing,” “notifying,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

The present invention also relates to apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-accessible storage medium includes any mechanism for storing or transmitting information in a form readable by a machine (e.g., a computer). For example, a machine-accessible storage medium includes read only memory (“ROM”), random access memory (“RAM”), magnetic disk storage media; optical storage media, flash memory devices or other type of machine-accessible storage media.

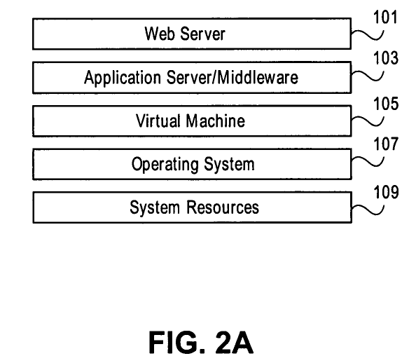

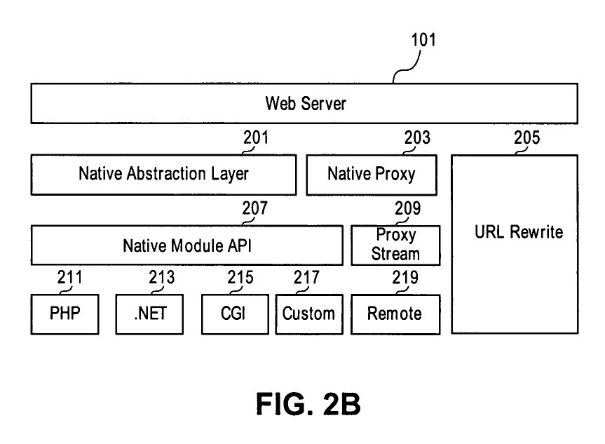

FIG. 2A is a diagram of one embodiment of a system for providing a web server that supports a hybrid connection model. A web server 101 is a software application that services requests for data from remote client applications over a network. The term web server is sometimes used to refer to the machine that executes the web server software and to relate to the specific handling of hypertext transfer protocol (HTTP) requests. As used herein, a web server refers to a software application for servicing requests for resources from a client that may include HTTP requests as well as other types of requests. The servicing of HTTP requests will be used as an example throughout for sake of clarity. The servicing of HTTP requests is typically through providing hypertext markup language (HTML) documents often referred to as web pages to requesting client applications.

The web server 101 relies on a number of underlying programs and system components to support its functionality. The underlying programs include application server/middleware 103, virtual machine 105, operating system 107 and system resources 109. The application server/middleware 103 is an optional component that provides communication and data access services to applications. In another embodiment, the web server 101 is a standalone program that does not rely on an application server/middleware 103. Application servers/middleware 103 may be used to simplify the operation and maintenance of the applications it supports including the web server 101. The application server/middleware 103 can also be used to improve performance, security, data management and similar features.

In one embodiment, the application server/middleware 103 may run on a virtual machine 105. A virtual machine 105 is an abstraction of a platform or computer system that applications and programs can be designed to run on without the need to program them for specific hardware configurations. A common application server and virtual machine combination is Java® 2 Enterprise Edition (J2EE) by Sun Microsystems of Santa Clara, Calif. J2EE is a platform for server programming in the Java language. J2EE provides a set of libraries that provides functionality to support fault-tolerant, distributed, multi-tier Java programs.

The virtual machine 105 relies on an operating system 107 to directly manage the resources 109 of the system through the management of processes, threads, interrupts and similar elements. Any operating system 107 can be utilized including any of the Windows® operating systems by Microsoft Corp. of Redmond, Wash., the Unix® operating system, the Linux operating system, OS X by Apple, Inc. of Cupertino, Calif. or similar operating systems. The operating system 107 manages the system resources 109 including memory, networking, security, file and disk management and similar aspects of a computer system or similar machine. The system resources 109 can be in any configuration, amount, size or arrangement. The system resources 109 may be those of a desktop computer, server, mainframe, cluster or similar system or group of systems.

FIG. 2B is a diagram of one exemplary embodiment including a detailed organization of web server related modules. A web server 101 is composed of a set of modules or relies on a set of related modules, which may be part of the web server layer or lower layers of the hierarchy. The illustrated web server 101 design is one example embodiment. One of ordinary skill in the are would understand that many of the components could be omitted and that other similar components could be added depending on the requirements of the administrator of the web server 101.

The web server may be divided into its main functionality, web server application 101, and the supporting components. The main functionality of the web server 101 is to handle HTTP requests and similar requests. However, these requests can sometimes rely on other components in order to determine a response or completely process an HTTP request. The supporting components can include a native abstraction layer 201, native proxy 203, uniform resource locator (URL) rewrite module 205, native module advance programmer interface (API) 207, proxy stream 209, PHP module 211, .Net module 213, CGI module 215, a custom module 217, a remote module 219 or similar modules.

The native abstraction layer 201 is a set of libraries that abstract operating system functionality. This allows the web server 101 to be programmed without the need for the code to be specific to a particular operating system. Instead the web server utilizes the procedures and methods of the native abstraction layer, which then affect the desired functionality by interaction with the operating system.

The native proxy module 203 is an abstraction that provides the web server 101 with access to legacy subsystems. The native proxy module 203 provides out of process execution and procedure calls for external processes or across different virtual machines. This increases the overall security by allowing the execution of application code under different security contexts than the one used by the web server 101.

The uniform resource locator (URL) rewrite module 205 is a rule-based rewriting engine (based on a regular-expression parser) that rewrites requested URLs on the fly. It supports an unlimited number of rules and an unlimited number of attached rule conditions for each rule to provide a flexible and powerful URL manipulation mechanism. The application of these URL manipulations can be contingent on any number of conditions or parameters, for instance web server variables, operating environment variables, received HTTP headers, time stamps and external database lookups. URL rewrite module 205 services are typically used to replicate or service web servers that map URLs to a file system. The URL rewrite module 205 may also be used to make website URLs more user friendly, prevent in-line linking, mask the organization or working of a website.

A native module API 207 is a set of libraries that provide an abstraction layer for various legacy subsystems that are heavily reliant on HTTP. The native module API 207 is responsible for loading legacy applications inside the process address space of the running web server. Allows the web server to access and utilize older modules and resources such as native operating system modules that are specifically written to utilize this API. Native module API 207 supports modules that are written to be tightly coupled with the operating system for tasks such as logging, user authentication and authorization and similar tasks.

A proxy stream 209 communication protocol such as the AJP protocol or a similar protocol that also supports using operating system advanced connection mechanisms like Unix Domain Sockets or Microsoft Windows Named Pipes. The proxy stream 209 offers both connection reuse and connection multiplexing. In one embodiment, the data transferred can be encrypted, thereby improving security without the need for special network hardware or a special network topology. The proxy steam protocol gives transparent access to the out-of-process legacy subsystems that can be hosted on a remote machine.

The PHP module 211 supports the PHP scripting language that is often used to generate dynamic content for web pages. The .NET module 213 is a software component that provides a large body of pre-coded solutions to common program requirements, and manages the execution of programs written specifically for the .NET framework. The common gateway interface (CGI) module 215 is a standard protocol for interfacing external application software with an information server, such as the web server. The protocol allows the web server to pass requests from a client web browser to the external application. The web server can then return the output from the application to the web browser. A custom module 217 is a module written by a user that executes within a running virtual machine using a web server module API. Custom modules 217 can be used to change the existing data delivered to the client or received from the client. Custom modules 217 can be stacked in such a way that output from one c 217ustom module is input to another custom module 217. A remote module 219 is a custom module written by a user that executes outside a running virtual machine using the virtual machine's own remote procedure calling API.

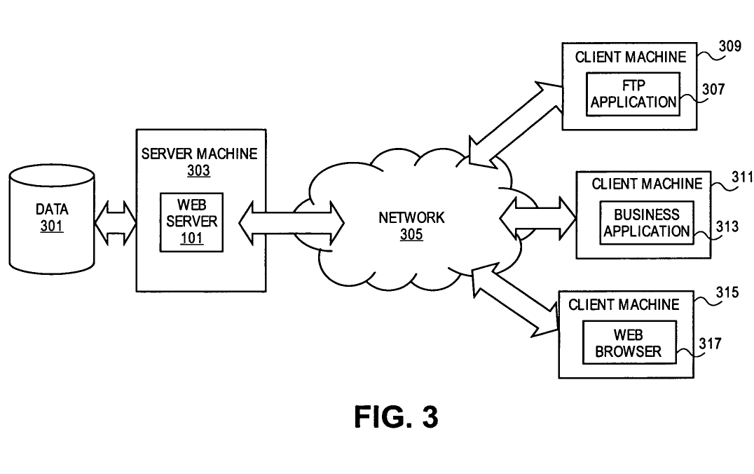

FIG. 3 is a diagram of one embodiment of a network for providing web services using the hybrid connection model. In one embodiment, the web server 101 implementing the hybrid connection model is executed by a server machine or set of server machines 303. In another embodiment, the hybrid connection model is implemented as a discrete program separate from the web server 101, which then calls on the hybrid connection model program to manage connections with client applications. The server machine 303 can be any server or number of servers. The server machine 303 can be a dedicated server machine, desktop computer, laptop computer, handheld device, console device or similar device. The server machine 303 may also execute other applications and programs in support of the web server 101 such as database management programs, virtual machines, application servers and similar programs. In one embodiment, the server machine 303 is in communication with a storage device 301 to store data to be accessed and utilized by the web server 101 and associated programs. The data may be stored in a database, file system or similar data structure. The database may be a relational database, object oriented database or similar database.

The server machine 303 is in communication with a set of client machines 309, 311, 315 over a network 305. The network 305 can be any type of network including a local area network (LAN), wide area network (WAN), such as the Internet, or similar network. The network 305 could be a private or public network and include any number of machines in communication with one another through any number and combination of communication mediums and protocols.

The web server 101, depending on the type of resource offered, can service requests from any number or type of clients including web browsers 317, business applications 313, file transfer protocol (FTP) application 307 and similar applications. These applications open connections with the web server 101 to send requests such as requests for files. The connections are closed when the client application has received the information it requires. A web server 101 supports separate connections for each client application that connects to the web server 101 or in some instances multiple connections for each client application.

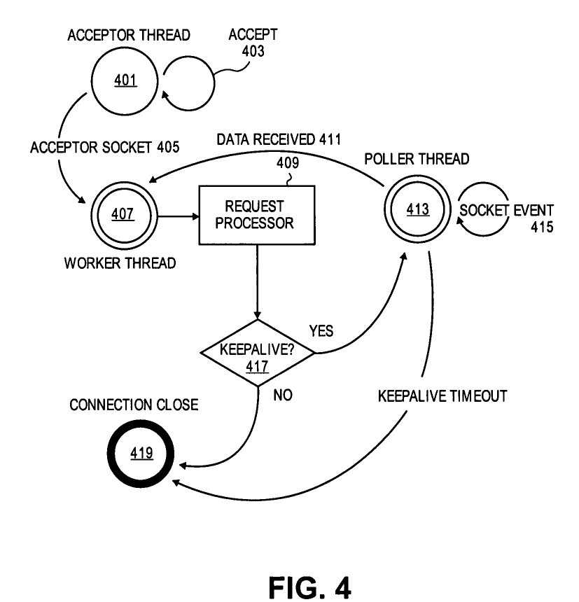

FIG. 4 is a flowchart of one embodiment of a hybrid connection model. The hybrid connection model is the method by which the web server handles incoming connection requests and service requests on those connections. The process of servicing a client is initiated through an acceptor thread (block 401). A thread of execution (a ‘thread’ as used herein) is created by an operating system to execute a program or a portion of a program. The acceptor thread continually looks for incoming connection request on ports of the server system (block 403). The acceptor thread may poll ports or handle specified interrupts generated by these ports. The acceptor thread accepts an incoming connection request as a socket (block 405). One skilled in the art would understand that the hybrid connection model can be implemented for use with any connection protocol or mechanism such as sockets, pipes or similar connection mechanisms. Sockets are used as an example herein for sake of clarity. The accepted socket is assigned to a worker thread (block 407).

Each accepted socket has its own worker thread to handle the incoming and outgoing data on the connection. The worker thread handles all of the incoming data, which may include HTTP requests and similar types of data and provides an appropriate response. The worker thread is scheduled to a processor of the server machine to process the incoming data and provide response data (block 409). The server machine can have any number of processors and generally the operating system handles the scheduling of the processes and threads to available processors.

After the incoming data has been processed, then a check is made to determine whether a connection is to be kept alive (block 417). The check can be based on receiving a close connection command or similar incoming data that indicates that the connection is no longer needed. If it is determined that the connection is no longer needed, then the connection is closed (block 419). Closing the connection frees the thread assigned to the connection.

If it is determined that the connection is not to be closed, but there is no further data to process currently, then the connection is assigned to the poler thread (block 413). The worker thread is released. The poler thread is a thread that continually checks for incoming data for each open connection that has been assigned to the poler thread. A single poler thread or a set of poler threads listen to each socket for a socket event (block 415). Use of a poler thread reduces required system resources that would have been utilized for each worker thread assigned to an idle socket. If a socket event is detected, then the associated socket is reassigned a worker thread (block 407) to process the incoming data (block 409).

Connections that have not been properly closed can be detected by a keep alive timeout. A timer can be initiated each time a connection is assigned to the poler thread. If a socket event is not detected within the keep alive time out period, then the socket will automatically be closed (block 419).

The web server and hybrid connection model implementation can be stored in a machine-accessible storage medium such as a storage device in communication with the server machine. While a machine-accessible storage medium is given in this exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories and optical and magnetic media.

Thus, a method and apparatus for managing hybrid connection model been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A computer-implemented method comprising:
accepting a connection request by an acceptor thread;
assigning the connection to a worker thread to service data transfer over the connection;
assigning the connection to a polling thread to detect connection events; and
servicing a transfer of data through the connection by the worker thread.

2. The computer-implemented method of claim 1, further comprising:
determining whether a connection end condition for the connection is met.

3. The computer-implemented method of claim 1, further comprising:
requesting a processor by the worker thread to service the transfer of data.

4. The computer-implemented method of claim 1, further comprising:
assigning the connection to the worker thread in response to an event detected on the connection.

5. The computer-implemented method of claim 1, further comprising:
releasing the acceptor thread in response to assigning the connection to the worker thread.

6. The computer-implemented method of claim 1, further comprising:
releasing the worker thread in response to receiving an indicator from an associated process then assigning the connection to the polling thread.

7. The computer-implemented method of claim 1, further comprising:
closing the connection in response to a time out expiration.

8. The computer-implemented method of claim 1, further comprising:
notifying an associated process of a time out expiration.

9. A machine readable medium, having instructions stored therein, which when executed, cause a machine to perform a set of instructions comprising:
accepting a connection request by an acceptor thread;
assigning the connection to a worker thread to service data transfer over the connection;
assigning the connection to a polling thread to detect connection events; and
servicing a transfer of data through the connection by the worker thread.

10. The machine readable medium of claim 9, having further instructions stored therein, which when executed perform a set of operations further comprising:
determining whether a connection end condition for the connection is met.

11. The machine readable medium of claim 9, having further instructions stored therein, which when executed perform a set of operations further comprising:
requesting a processor by the worker thread to service the transfer of data.

12. The machine readable medium of claim 9, having further instructions stored therein, which when executed perform a set of operations further comprising:
assigning the connection to the worker thread in response to an event detected on the connection.

13. The machine readable medium of claim 9, having further instructions stored therein, which when executed perform a set of operations further comprising:
releasing the acceptor thread in response to assigning the connection to the worker thread.

14. The machine readable medium of claim 9, having further instructions stored therein, which when executed perform a set of operations further comprising:
releasing the worker thread in response to notifying an associated process of a time out expiration the connection to the polling thread.

15. The machine readable medium of claim 9, having further instructions stored therein, which when executed perform a set of operations further comprising:
closing the connection in response to a time out expiration.

16. The machine readable medium of claim 9, having further instructions stored therein, which when executed perform a set of operations further comprising:
notifying an associated process of a time out expiration.

17. An apparatus comprising:
a web server to service data requests from a client application; and
a hybrid connection manager to assign an idle connection with a client of the web server to a shared poller thread.

18. The apparatus of claim 17, wherein the hybrid connection manager reassigns the connection to a worker thread in response to a socket event.

19. The apparatus of claim 17, wherein assignment of the connection to the shared poller starts a timeout operation.

20. The apparatus of claim 17, wherein the hybrid connection manager is integrated within the web server.
